(19) United States
(12) Patent Application Publication
(10) Pub. No.: US 2019/0023320 A1
(43) Pub. Date: Jan. 24, 2019

(54) VEHICLE CONTROLLER AND METHOD

(71) Applicant: Jaguar Land Rover Limited, Whitley (GB)

(72) Inventors: Elliot HEMES, Whitley (GB); David Armstrong, Whitley (GB)

(21) Appl. No.: 16/014,345

(22) Filed: Jun. 21, 2018

(30) Foreign Application Priority Data
Jul. 21, 2017 (GB) 1711752.4

(51) Int. Cl. B62D 15/02; B60W 30/10; B60W 50/16

(52) U.S. Cl. CPC B62D 15/029; B62D 15/026; G05D 1/0248; B60W 50/16; B60W 30/10

(57) ABSTRACT

A method for providing a steering course for a vehicle is described, the vehicle having at least one wheel travelling on a driving surface alongside a raised boundary to the driving surface. The method comprises receiving steering information, the steering information indicative of a steering condition of the vehicle. The method comprises receiving terrain information, the terrain information indicative of a direction of the boundary. The method comprises providing, in dependence on the steering information and the direction of the boundary, a steering course for the vehicle. A computer-readable medium, a controller, a system and a vehicle are also provided.

### CROSS-REFERENCE TO RELATED APPLICATION

This application claims priority under 35 U.S.C. § 119 to Great Britain Application No. 1711752.4, filed Jul. 21, 2017, the content of which is incorporated herein by reference in its entirety.

### TECHNICAL FIELD

The present disclosure relates to a vehicle controller and method, and particularly, but not exclusively, to a controller and method for providing a steering course for a vehicle. Aspects of the invention relate to a method, to a computer readable medium, to a controller, to a system and to a vehicle.

### BACKGROUND

When riding or driving in a vehicle, it is difficult to see what lays directly ahead of the vehicle, and particularly what lays directly ahead of one or more wheels of the vehicle, as the front or bonnet of the vehicle often obscures the vehicle occupants' field of view. In certain driving conditions, such as when a wheel of the vehicle is driven in a rut, there can also be a discrepancy between the direction of the vehicle's travel and a direction corresponding to a steering condition of the vehicle. In ruts, particularly when wet, tyres of wheels being driven at a steering angle into steep and high walls of the rut cannot, due to the slipperiness of the mud, generate sufficient friction to climb up the rut wall and out of the rut. Nevertheless, the driving of the wheels of the vehicle continues to propel the vehicle forwards along the rut even though the steering angle is not along the direction of the rut, but instead into the rut wall. This can increase the risk of harm coming to one or more occupants of the vehicle. For example, if a driver of the vehicle is unaware of the steering angle applied when a wheel of the vehicle is travelling in a rut, then there is a risk that, once the depth of the rut decreases to an extent that the wheel can exit the rut, the vehicle may lurch out of the rut unexpectedly with potentially dangerous consequences.

It is an aim of the present invention to address the above and related disadvantages.

### SUMMARY OF THE INVENTION

Aspects and embodiments of the invention provide a method, a computer readable medium, a controller, a system and a vehicle as claimed in the appended claims.

According to an aspect of the invention, there is provided a method for providing a steering course for a vehicle. The vehicle has at least one wheel travelling on a driving surface alongside a raised boundary to the driving surface. The method comprises receiving steering information, the steering information indicative of a steering condition of the vehicle. The method further comprises receiving terrain information from sensing means, the terrain information indicative of a direction of the boundary. The method further comprises providing, in dependence on the steering information and the direction of the boundary, a steering course for the vehicle.

Advantageously, by providing a method as described herein, a steering course may be provided to the occupant(s) of a vehicle to assist in steering the vehicle in situations in which a steering condition of the vehicle does not correspond to the direction of motion of the vehicle when the vehicle is being driven alongside a raised boundary. Accordingly, the described method improves the safety and comfort of all occupants and decreases the risk of damaging the vehicle. Further advantageously, a steering course is provided in situations in which the occupants of the vehicle cannot clearly see what lays ahead of a wheel of the vehicle.

The method may comprise determining, from the terrain information, the direction of the boundary.

Providing a steering course for the vehicle may comprise providing an indication to align the wheel of the vehicle with the direction of the boundary. The method may comprise aligning the wheel of the vehicle with the direction of the boundary. Advantageously, aligning the wheel of the vehicle with the direction of the boundary optimises a driving direction of the wheel and the motion of the vehicle, reduces the chance of the vehicle unexpectedly climbing up and over the boundary and changing direction at speed, which increases the safety and comfort of the occupants of the vehicle.

The wheel may be travelling in a rut, and the direction of the boundary may comprise the direction of the rut. When driving in ruts, there may be a discrepancy between a steering condition of the vehicle and the direction in which the vehicle travels due to torque from contact between the sidewall(s) of the wheel(s) and the sides of the ruts. Accordingly, the claimed method advantageously allows for this discrepancy to be corrected for, thereby improving the safety and comfort of the occupants of the vehicle.

Providing a steering course for the vehicle may comprise providing an indication for steering the wheel out of the rut. Advantageously, providing an indication for steering the wheel out of the rut assists the vehicle in getting to a surface on which he steering of the vehicle is more controllable.

The method may comprise determining, from the terrain information, a depth of the rut. This may be useful, for example, when determining whether to align a wheel with the direction of the rut or whether to escape the rut. For example, if the rut is too deep, then the wheel will be unable to escape the rut and so, for safety and comfort, it may be more desirable to align the wheel with the direction of the rut. However, if the rut is not too deep then the wheel may be able to escape the rut. Determining the depth of the rut may comprise determining the depth of the rut at a predetermined distance from the vehicle in the direction of the rut. Accordingly, if the depth of the rut is identified at a given location ahead of the vehicle, then a suitable steering course may be determined and provided in good time before the vehicle reaches that location, which is particularly advantageous in situations in which the required steering course is complicated. The method may comprise determining that the depth of the rut is below a threshold depth.

The driving surface may comprise a road carriageway and the boundary to the driving surface may comprise a kerb. The method may comprise determining, from the terrain information, a height of the kerb. Determining the height of the kerb may comprise determining the height of the kerb at a predetermined distance from the vehicle in the direction of the kerb. The method may comprise determining that the height of the kerb is below a threshold height. A steering course may therefore be indicated when the presence of a drop kerb or a raised carriageway is detected.

The steering information may comprise a steering angle. The steering information may comprise a measurement of torque from contact between the wheel and the boundary.

The terrain information may comprise a yaw rate measurement. The terrain information may comprise three-dimensional image data. Receiving terrain information from sensing means may comprise receiving the terrain information from a stereoscopic three-dimensional camera. The terrain information may comprise suspension information.

The steering course may comprise a steering angle. The steering course may comprise a path recommendation.

According to a further aspect of the invention there is provided computer software which, when executed by a computer is arranged to perform a method as disclosed herein.

According to another aspect of the invention, there is provided a computer readable medium having instructions stored thereon which, when read by a processing means, cause the processing means to perform a method as disclosed herein. The computer readable medium may be non-transitory. The instructions may be tangibly stored on the computer readable medium.

According to another aspect of the invention, there is provided a controller for a vehicle having at least one driven wheel. The controller is operable to provide a steering course for the vehicle when the wheel is travelling on a driving surface alongside a boundary to the driving surface. The controller comprises input means for receiving steering information and for receiving terrain information from sensing means, wherein the steering information is indicative of a steering condition of the vehicle, and wherein the terrain information is indicative of a direction of the boundary. The controller further comprises processing means for determining, in dependence on the steering information and the direction of the boundary, a steering course for the vehicle. The controller further comprises output means for providing the steering course for the vehicle.

The processing means may be for determining, from the terrain information, the direction of the boundary.

The driving surface may comprise a rut, and the direction of the boundary may comprise the direction of the rut. The processing means may be for determining a depth of the rut. The processing means may be for determining that the depth of the rut is below a threshold depth.

The driving surface may comprise a road carriageway and the boundary to the driving surface may comprise a kerb. The processing means may be for determining a height of the kerb. The processing means may be for determining that the height of the kerb is below a threshold height.

The input means may comprise a first input means for receiving the steering information and a second input means for receiving the terrain information. For example, steering information and terrain information may be received from different sources.

An input means may comprise an input for receiving an electrical signal. In some embodiments, a first electrical signal may provide the steering information. In some embodiments, a second electrical signal may provide the terrain information. The processing means may comprise one or more processing devices or electronic processing devices.

According to another aspect of the invention, there is provided a system for a vehicle having at least one driven wheel, the system being operable to provide a steering course for the vehicle when the wheel is travelling on a driving surface alongside a boundary to the driving surface. The system comprises sensing means for receiving terrain information, the terrain information indicative of a direction of the boundary. The system further comprises a controller as described herein. The sensing means may be a three-dimensional sensing means. The sensing means may comprise a stereoscopic three dimensional camera.

According to another aspect of the invention, there is provided a vehicle having at least one wheel, the vehicle including a system as described herein.

Any controller or controllers described herein may suitably comprise a control unit or computational device having one or more electronic processors. Thus the system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. A first controller may be implemented in software run on one or more processors. One or more other controllers may be implemented in software run on one or more processors, optionally the same one or more processors as the first controller. Other suitable arrangements may also be used.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 illustrates a vehicle on a driving surface;

FIG. 2 is a block diagram of a system;

FIG. 3 is a flow chart;

FIG. 4 illustrates a vehicle on a second driving surface; and

FIG. 5 is a flow chart.

Throughout the description and the drawings, like reference numerals refer to like parts.

### DETAILED DESCRIPTION

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

In what follows, steering information may comprise any information from which a steering condition of the vehicle can be derived. For example, the steering information may comprise the steering angle applied to the steering wheel of the vehicle, which will indicate a corresponding intended angle of the one or more wheels of the vehicle.

In what follows, terrain information comprises information concerning a driving surface on which a vehicle is located, and/or information from which a condition of the driving surface may be inferred. The terrain information may comprise, for example, image data from a field of view of a camera, such as a stereoscopic camera, mounted on a vehicle. The terrain information may comprise, for example, yaw rate measurements which describe the vehicle's angular velocity around its vertical axis, from which indirectly information concerning the driving surface on which the vehicle is located may be determined. A slip angle for the vehicle, which corresponds to the angle between the vehicle's heading (as indicated by the steering information) and the vehicle's actual movement direction may be determined using the yaw rate.

In what follows, the skilled person would understand that a raised boundary to a driving surface may comprise a boundary having an associated height or depth relative to the driving surface. Such a boundary may comprise, for example, a kerb, a rut sidewall, a wall, or other object which can be said to limit the extent of the driving surface in at least one direction. A direction of the boundary may be understood to mean a direction in which the kerb, rut sidewall, wall or other object acts as a boundary to the driving surface. For example, if the driving surface is a road carriageway and the boundary to the surface is a kerb, then the direction of the kerb may be understood as the direction in which the kerb extends with the road carriageway. If a wheel of a vehicle is travelling in a rut, then the direction of the boundary can be understood to mean the direction in which the rut extends. Accordingly, the skilled person would understand that a wheel travelling on a driving surface alongside a raised boundary to the driving surface may mean a wheel travelling substantially in the direction of the boundary, whether the wheel is angled at a steering angle substantially parallel with the boundary or against the boundary.

The words “height” and “depth” have been used interchangeably throughout this specification and can be considered to mean the same thing. That is a “height” of a kerb can be understood to mean a “depth” of a kerb, and a “height” of a rut can be understood to mean a “depth” of a rut. Height and depth are thus only to be understood as terms describing the substantially vertical extent of an object relative to a driving surface.

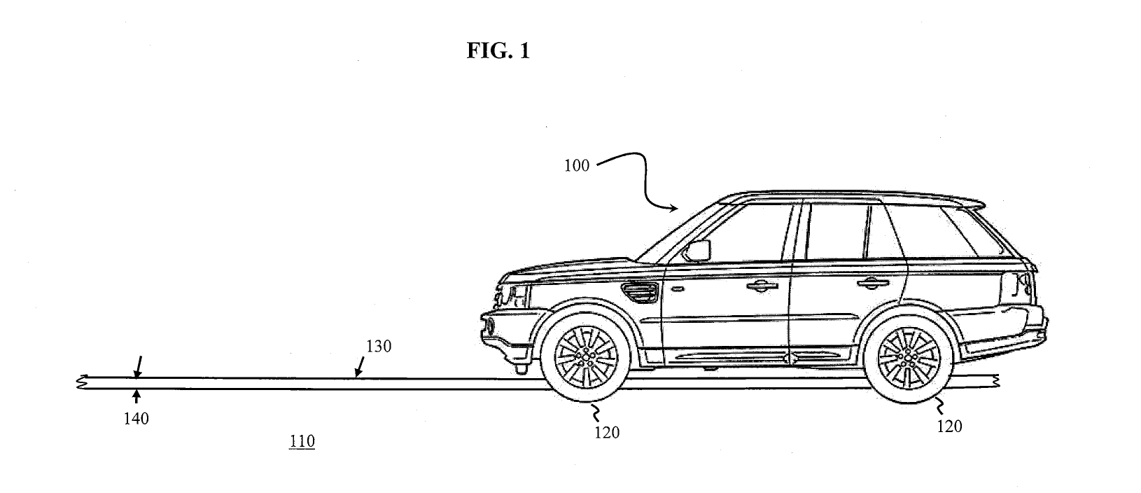

FIG. 1 illustrates a vehicle 100 on a driving surface 110. The vehicle 100 has four wheels 120, two of which are not shown in the figure. The vehicle is situated on a driving surface 110, which in this example is a road carriageway surface. The driving surface 110 has a raised boundary 130, which in this example is a kerb. The kerb 130 has an associated height 140 which may vary along the length of the kerb. For example, if the carriageway 110 is bordered by a dropped kerb (not shown) then the height of the kerb relative to the carriageway 110 will be substantially decreased for the length of the dropped kerb. Similarly, in some stretches of road the carriageway 110 may be raised such that the height of the kerb 130 relative to the carriageway 110 is substantially decreased.

The vehicle 100 includes sensing means such as one or more sensors (not shown in FIG. 1) and controlling means, such as a controller. Sensing means and controlling means will be described in more detail below.

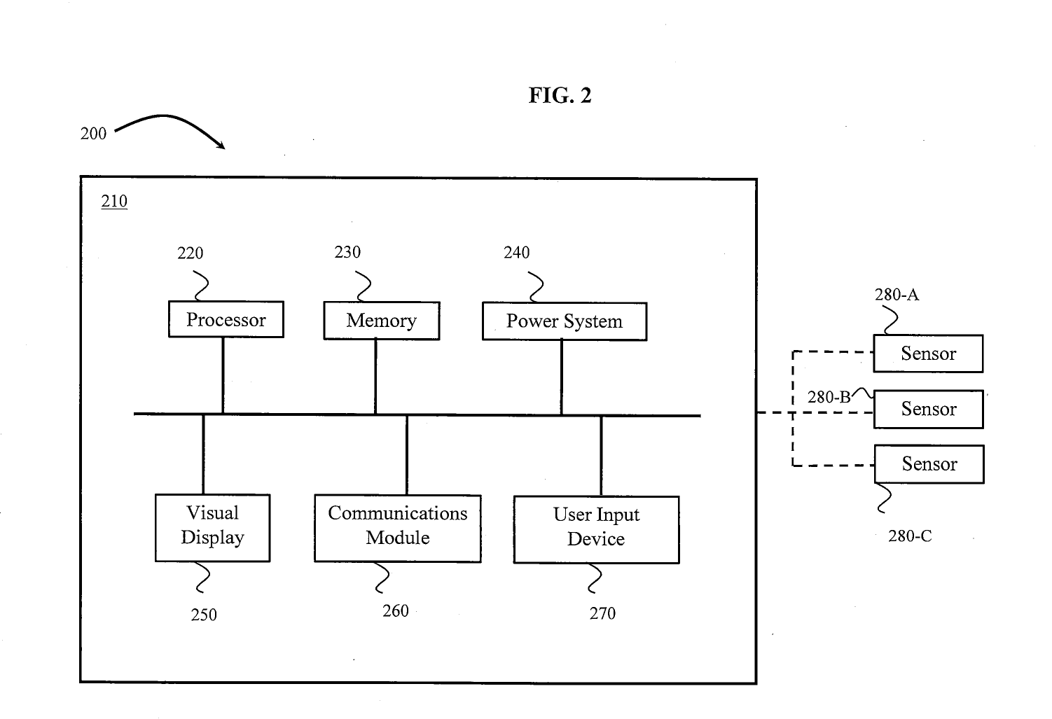

FIG. 2 is a block diagram of a system 200 for a vehicle such as vehicle 100 having at least one driven wheel 120. The system 200 is operable to provide a steering course/steering advice/a steering recommendation for the vehicle when the wheel is travelling on a driving surface, such as driving surface 110, alongside a boundary to the driving surface, such as kerb 130. Other architectures to that shown in FIG. 2 may be used as will be appreciated by the skilled person.

The system 200 comprises sensing means, which in the embodiment shown in FIG. 2 comprises a plurality of sensors 280-A, 280-B and 280-C. The skilled person will understand that although the sensing means of the present embodiment comprises three sensors, more or fewer sensors may be utilised and any suitable sensing means may be used. The sensing means 280-A, 280-B, 280-C are operable to receive information concerning the surroundings of the vehicle, for example information concerning the driving surface, the boundary to the driving surface and the height of the boundary to the driving surface relative to the driving surface.

The system 200 further comprises controlling means, which in the present embodiment comprises a controller 210. The controller 210 includes a number of user interfaces including a virtual or dedicated user input device 270.

Referring to the figure, the controller 210 comprises input means for receiving steering information and terrain information from the sensing means 280-A, 280-B, 280-C. In the example shown, the input means comprises a communications module 260 for sending and receiving communications between a processing means 220 and a sensing means 280-A, 280-B and 280-C. The communications module may comprise multiple electrical inputs. For example, the communications module 260 may be used to receive terrain information from one of the vehicle's sensors at a first electrical input and may be used to receive steering information from another of the vehicle's sensors at a second electrical input, the terrain information indicative of a direction of the boundary to the driving surface, the sensing information indicative of a steering condition of the vehicle.

The controller 210 of the present embodiment comprises processing means in the form of a processor 220, a storage means in the form of a memory 230, and a powering means in the form of a power system 240. The processor may comprise one or more electronic processing devices 220.

The processing means 220 is configured to receive data, access the memory 230, and to act upon instructions received either from said memory 230, from communications module 260 or from user input device 270. The processor 220 is arranged to receive steering information from the communications module 260. The processor 220 is arranged to receive terrain information indicative of the direction of the boundary from the communications module 260, which in turn is configured to receive the terrain information from the sensing means 280-A to 280-C. The processor 220 is arranged to determine, in dependence on the steering information and the direction of the boundary, a steering course for the vehicle.

The controller further comprises output means, which may comprise an electrical output, for providing the steering course for the vehicle. In the present example, the output means comprises a visual display unit 250. The processor 220 is therefore arranged to provide the steering course for the vehicle via the visual display 250, although the skilled person would understand that the steering course may be provided in any suitable way, for example using an audible notification. The electrical output may be configured to provide a control signal. The control signal may be used to control the vehicle, for example the steering of the vehicle.

The skilled person would understand that the controller 210 may be separate to the vehicle 100. For example, the controller 210 may be provided in the form of a standalone module connectable with an interface of the vehicle 100. In this way, the controller 210 may communicate with the sensing means 280 of the vehicle 100 via the communications module 260. The skilled person would also understand that the controller 210 may be built into or installed in the vehicle 100, such that the processing means 220 is a processing means of the vehicle 100 and the input means and output means are respectively input means and output means of the vehicle.

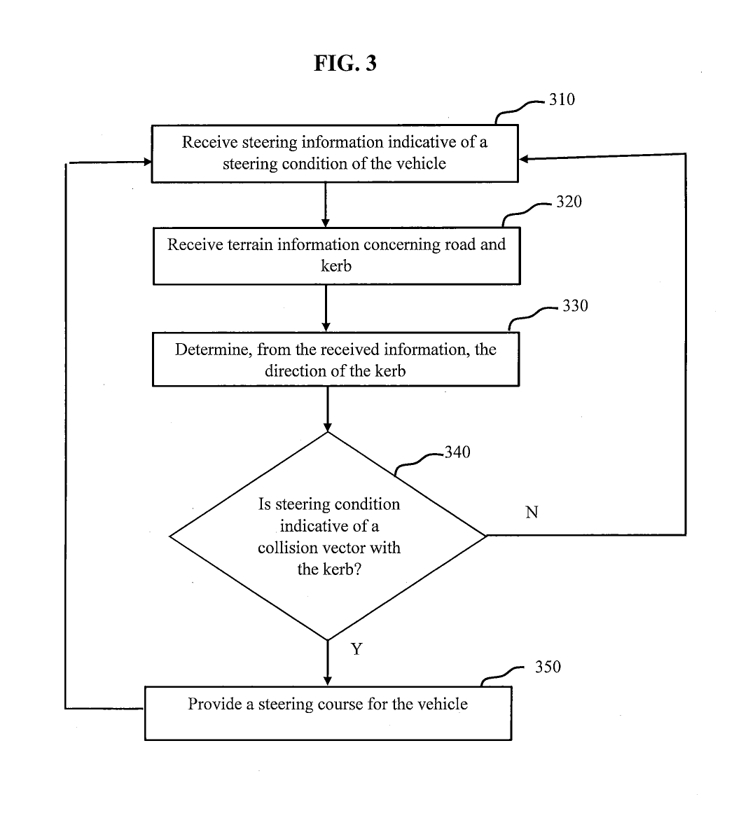

FIG. 3 is a flowchart of a method according to an embodiment. The method may be performed by a computing device such as controller 210. The method may be used, for example, to provide a steering course to a vehicle 100 on a road carriageway surface 110 near a kerb 130.

At step 310, steering information is received. The steering information is indicative of a steering condition of the vehicle 100. The steering information may comprise a steering angle, which can be used to indicate that the yaw rate of the vehicle 100 should, under normal conditions, change, due to the vehicle turning to the left or right in transit. In order to infer the steering condition of the vehicle, the steering information may be processed.

At step 320, terrain information is received, the terrain information concerning the road and the kerb and indicative of the direction of the kerb. The terrain information may be received from any suitable vehicle sensor, such as a stereoscopic three-dimensional camera. The terrain information may be in the form of, for example, visual information to be analysed by processing means of the controller. The terrain information may include, for example, a yaw rate of the vehicle which corresponds to an indication of the driving surface on which the wheels are travelling. The yaw rate, in conjunction with received steering information, can be used to indicate that the vehicle 100 is travelling in a first direction while the steering angle would suggest that the vehicle 100 should be travelling in a second direction.

The skilled person would appreciate that, although in the terrain information is shown in the figure as received after the receipt of the steering information, the terrain information and the steering information may be received in any order or simultaneously, and that the receiving of the terrain information and/or sensing information may be substantially continuous or periodic.

At step 330, a determination is made of the direction of the kerb. From the steering condition of the vehicle 100 and the direction of the kerb, a determination is made as to whether or not the vehicle 100 is on a collision vector with the kerb 130. That is, a determination is made as to whether the vehicle will collide with the kerb if the vehicle continues its present course. If, at step 340, a determination is made that the steering condition is not indicative of the vehicle 100 being on a collision vector with respect to the kerb, then the method returns to step 310. If, at step 340, the steering condition of the vehicle 100 is indicative of the vehicle 100 being on a collision vector with respect to the kerb, then the method proceeds to step 350.

At step 350, a steering course is provided for the vehicle. The steering course may be provided to the user of the vehicle via a visual display and/or an audible sound, or via any other suitable means. The method then returns to step 310.

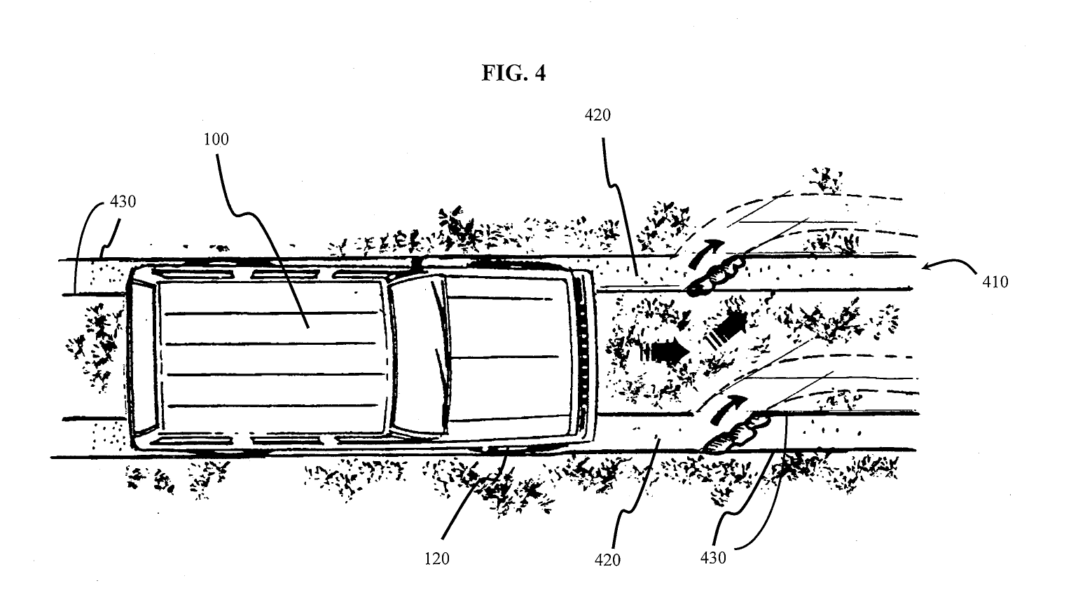

FIG. 4 illustrates a vehicle 100 on a second driving surface 410. In particular, the vehicle 100 is shown travelling in ruts 420. That is, the wheels 120 of the vehicle 100 are travelling in ruts alongside the sidewalls 430 of the ruts which act as raised boundaries. The ruts 420 have an associated height/depth (not shown) which can be determined by a system such as system 200 of the vehicle 100. Processing means of the vehicle 100 is configured to receive terrain information concerning the ruts 420, the rut sidewalls 430 and the depth of the ruts, to receive steering information concerning a steering condition of the vehicle 100, and to provide a steering course for the vehicle based on the terrain information and the steering information. For example, if the processing means of the vehicle 100 determines that, at a predetermined distance ahead of the vehicle 100 in the direction of the ruts 420, the rut depth is below a predetermined threshold, then the steering course may be for steering the vehicle out of the ruts.

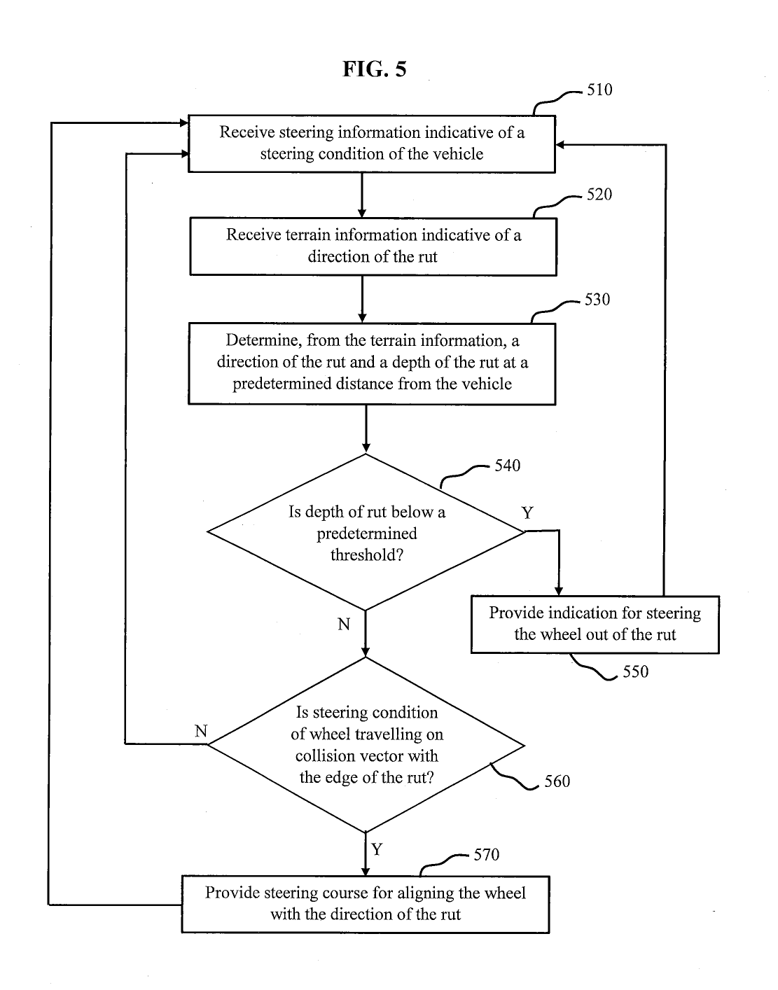

FIG. 5 is a flowchart of a method according to an embodiment. The method may be performed by a computing device such as controller 210. The method may be used, for example, to provide a steering course to a vehicle 100 with at least one wheel 120 travelling in a rut 420.

At step 510, steering information is received. The steering information is indicative of a steering condition of the vehicle 100. The steering information may comprise a steering angle, which can be used to indicate that, if the wheel of the vehicle was not in the rut, the vehicle 100 would turn to the left or right in transit. The steering information may comprise, for example, a yaw rate, which in conjunction with other steering information can be used to indicate that the vehicle 100 is travelling in a first direction while the steering angle would suggest that the vehicle 100 should be travelling in a second direction. For example, if the yaw rate is substantially zero, but the steering angle is not zero, then the vehicle 100 is likely in a rut.

At step 520, terrain information is received, the terrain information concerning the rut and indicative of the direction of the rut 420. As indicated above, yaw rate may alternatively, or in addition, be provided as part of terrain information. In the present example, the terrain information is further indicative of a depth of the rut at a predetermined distance ahead of the vehicle 100. The terrain information may be received from any suitable vehicle sensor, such as a stereoscopic three-dimensional camera. The terrain information may be in the form of, for example, visual information to be analysed by processing means of the controller 210.

The skilled person would appreciate that, although in the terrain information is shown in the figure as received after the receipt of the steering information, the terrain information and the steering information may be received in any order or simultaneously, and that the receiving of the terrain information and/or sensing information may be substantially continuous or periodic.

At step 530 the direction of the rut is determined from the terrain information. The rut depth at the predetermined distance ahead of the vehicle, in the direction of the rut, is also determined.

At step 540, a determination is made as to whether the rut depth is below a predetermined threshold height, the predetermined threshold indicative of a depth at which the wheel 120 of the vehicle 100 may exit the rut 420. If the depth of the rut at the predetermined distance from the vehicle is below the predetermined threshold, then the method proceeds to step 550. If the depth of the rut at the predetermined distance from the vehicle is not below the predetermined threshold, then the method proceeds to step 560.

At step 550, an indication is provided to a user or driver of the vehicle for steering the wheel out of the rut. That is a steering course is determined, based on the steering condition of the vehicle 100 and the direction of the rut 420 and the determination that the rut depth at the predetermined distance from the vehicle 100 in the direction of the rut 420 is below the predetermined threshold. The steering course is for exiting the rut where the depth of the rut is low enough to exit without damage to the vehicle. The steering course is then indicated to the user or driver of the vehicle 100, and the method returns to step 510 and continues while the wheel 120 of the vehicle 100 remains in the rut.

At step 560 a determination is made as to whether the steering condition of the vehicle 100 is indicative that the wheel 120 is on a collision vector with the sidewall of the rut, or whether the steering condition and terrain information indicate that the wheel is already travelling against or touching the sidewall of the rut. If a determination is made that the wheel 120 is not on a collision vector with the sidewall of the rut, then the method returns to step 510. If, however, a determination is made that the wheel 120 is on a collision course with the sidewall of the rut or is already against or in contact with the sidewall of the rut, then the method proceeds to step 570.

At step 570, a steering course is provided for the vehicle. In particular, as it was previously determined at step 540 that the height of the rut is too great for the wheel 120 of the vehicle 100 to exit the rut, the steering course comprises an instruction for aligning the wheel 120 with the direction of the rut. The steering course may be provided to the user of the vehicle via a visual display and/or an audible sound, or via any other suitable means. The method subsequently returns to step 510.

Variations of the described embodiments are envisaged, for example, the features of all of the disclosed embodiments may be combined in any way and/or combination, unless such features are incompatible.

The vehicle may comprise any wheeled vehicle, for example a car, a van, a lorry, a bike or a tractor. The vehicle may be a human-driven vehicle or an autonomous or semi-autonomous vehicle.

The skilled person would also appreciate that although in the described embodiments the raise boundary has comprised a kerb or a rut sidewall, any raised boundary, such as a wall or barrier, would also qualify.

Information, such as the terrain information and the sensing information, may be received from any suitable source. For example, information may be received through a communications module of the vehicle, which receives the information from a third party, such as a satellite or another vehicle. The information may be received through inter-vehicle communication. For example, a first vehicle may comprise one or more sensors and gather terrain information and then broadcast the terrain information to a second vehicle.

The information may be received directly from sensing means. Sensing means may comprise one or more sensors. The sensors may include: cameras, stereoscopic or otherwise, a LIDAR (Light Detection and Ranging) sensor, a sonar sensor, a laser imaging sensor, or a radar sensor. Any suitable sensing means may be used.

Terrain information may be used, for example, to form a three-dimensional map around the vehicle. Terrain information may comprise any suitable information from which a condition of the driving surface may be inferred. The terrain information may comprise information about, for example, the roughness of the driving surface.

A steering course for a vehicle may be provided in any suitable way. For example, the indication may be provided in the form of a visual display or notification, an audible instruction, voice command, or alert, or via a haptic feedback system. In some situations, such as when the vehicle is an autonomous vehicle, the system may take an action responsive to the steering course in order to, for example, exit a rut or align with a rut, or drive a predetermined distance from a kerb.

The above embodiments have been described by way of example only, and the described embodiments are to be considered in all respects only as illustrative and not restrictive. It will be appreciated that variations of the described embodiments may be made without departing from the scope of the invention which is indicated by the appended claims rather than by the foregoing description.

1. A method for providing a steering course for a vehicle, the vehicle having at least one wheel travelling on a driving surface alongside a raised boundary to the driving surface, the method comprising:
receiving steering information indicative of a steering condition of the vehicle;
receiving terrain information from a sensor, the terrain information indicative of a direction and a height of the boundary; and
providing, in dependence on the steering information and the direction of the boundary, a steering course for the vehicle.

2. The method according to claim 1, further comprising, subsequent to receiving the terrain information, determining, from the terrain information, at least one of: the direction of the boundary, and the height of the boundary.

3. The method according to claim 1, wherein providing a steering course for the vehicle comprises at least one of:
providing an indication to align the wheel of the vehicle with the direction of the boundary, and
controlling the wheel of the vehicle so as that it aligns with the direction of the boundary.

4. The method according to claim 1, wherein providing a steering course for the vehicle comprises providing an indication for steering the wheel across the boundary.

5. The method according to claim 2, wherein determining the height of the boundary comprises determining the height of the boundary at a predetermined distance from the vehicle in the direction of the boundary.

6. The method according to claim 1, further comprising, prior to providing the steering course for the vehicle, determining that the height of the boundary is below a threshold height.

7. The method according to claim 1, wherein the wheel is travelling in a rut, and wherein the direction of the boundary comprises the direction of the rut, or the driving surface comprises a road carriageway and the boundary to the driving surface comprises a kerb.

8. The method according to claim 1, wherein the steering information comprises at least one of a steering angle, and a torque from contact between the wheel and the boundary.

9. The method according to claim 1, wherein the terrain information comprises at least one of: a yaw rate measurement, and suspension information.

10. The method according to claim 1, wherein the terrain information comprises three dimensional image data, and optionally wherein receiving terrain information from the sensor comprises receiving the terrain information from a stereoscopic three-dimensional camera.

11. The method according to claim 1, wherein the steering course comprises at least one of: a steering angle, and a path recommendation.

12. A controller for a vehicle having at least one driven wheel, the controller operable to provide a steering course for the vehicle when the at least one driven wheel is travelling on a driving surface alongside a raised boundary to the driving surface, the controller comprising:
a communications module configured to receive steering information and for receiving terrain information from a sensor, wherein the steering information is indicative of a steering condition of the vehicle, and wherein the terrain information is indicative of a direction and a height of the boundary;
a processor configured to determine, in dependence on the steering information and the direction of the boundary, a steering course for the vehicle; and
an electrical output configured to provide the steering course for the vehicle.

13. The controller according to claim 12, wherein the processor is configured to determine from the terrain information at least one of: the direction of the boundary, and the height of the boundary.

14. The controller according to claim 13, wherein the processor is configured to determine that the height of the boundary is below a threshold height.

15. The controller according to claim 12, wherein the communications module comprises a first electrical input configured to receive the steering information and a second electrical input configured to receive the terrain information.

16. A system for a vehicle having at least one driven wheel, the system being operable to provide a steering course for the vehicle when the at least one driven wheel is travelling on a driving surface alongside a raised boundary to the driving surface, the system comprising:
a sensor configured to receive terrain information; and
a controller comprising:
a communications module configured to receive steering information and the terrain information, wherein the steering information is indicative of a steering condition of the vehicle, and wherein the terrain information is indicative of a direction and a height of the boundary;
a processor configured to determine, in dependence on the steering information and the direction of the boundary, a steering course for the vehicle; and
an electrical output configured to provide the steering course for the vehicle.

17. The system according to claim 16, wherein the sensor comprises a stereoscopic three-dimensional camera.

18. A vehicle, comprising:
at least one wheel; and
the system of claim 16.

19. A non-transitory computer readable medium comprising computer readable instructions that, when executed by a processor, cause performance of the method of claim 1.
